(19) United States
(12) Patent Application Publication
(10) Pub. No.: US 2025/0104412 A1
(43) Pub. Date: Mar. 27, 2025

(54) Method And Systems For Detecting A Workpiece

(71) Applicant: Siemens Aktiengesellschaft, München (DE)

(72) Inventors: Wei Yao, Chaoyang (CN); Dong Li, Beijing (CN); Chuan Yu Zhang, Beijing (CN)

(73) Assignee: Siemens Aktiengesellschaft, München (DE)

(21) Appl. No.: 18/887,545

(22) Filed: Sep. 17, 2024

(30) Foreign Application Priority Data
Sep. 22, 2023 (EP) 23198993.0

(51) Int. Cl. G06V 10/82; G06T 7/11; G06V 10/774

(52) U.S. Cl. CPC G06V 10/82; G06T 7/11; G06V 10/774

(57) ABSTRACT

Various embodiments of the teachings herein include a method for detecting a workpiece. An example includes: performing data augmentation on an original image of an original workpiece; performing training on a neural network model comprising multiple feature extraction branches to obtain a workpiece detection model based on a workpiece image group obtained through the data augmentation; converting the workpiece detection model into a lightweight workpiece detection model; and performing detection on workpieces with the same shape and at least one different dimension as the original workpiece based on the lightweight workpiece detection model.

### CROSS-REFERENCE TO RELATED APPLICATIONS

This application claims priority to EP Application Serial No. 23198993.0 filed Sep. 22, 2023, the contents of which are hereby incorporated by reference in their entirety.

### TECHNICAL FIELD

The present disclosure relates to artificial intelligence (AI) technology. Various embodiments of the teachings herein include methods and/or systems for detecting a workpiece.

### BACKGROUND

With the improvement of industrial automation, intelligent industrial robots are gradually replacing manual sorting tasks in various industrial scenarios, which not only improves work efficiency but also effectively saves production costs. To achieve intelligent sorting, robots need to use machine vision technology to automatically identify and locate the sorted mixture. With significant breakthroughs in feature extraction in deep learning technology, object detection technology based on deep learning can automatically extract comprehensive image features. However, in order to achieve high detection accuracy, deep learning-based object detection networks usually have deep network structures designed, which leads to a significant increase in their spatial and temporal costs. In general, performing AI based workpiece detection processing on image processors (GPUs) takes a long time and affects speed of entire process, making it difficult to implement on industrial edge (IE) devices.

### SUMMARY

Various embodiments of the teachings of the present disclosure include methods, apparatus, devices, and/or media for detecting a workpiece. For example, some embodiments include a method for detecting a workpiece comprising: performing data augmentation on an original image of an original workpiece; performing training on a neural network model comprising multiple feature extraction branches to obtain a workpiece detection model based on a workpiece image group obtained through the data augmentation; converting the workpiece detection model into a lightweight workpiece detection model; and performing detection on workpieces with the same shape and at least one different dimension as the original workpiece based on the lightweight workpiece detection model. Therefore, new workpieces of different dimensions can be detected quickly based on model trained on data augmentation. Multiple feature extraction branches can improve detection performance. Moreover, lightweight workpiece detection model facilitates deployment work and reduces resource pressure on deployment side, especially suitable for edge devices.

In some embodiments, performing data augmentation on an original image of an original workpiece comprises generating a new workpiece image in the workpiece image group based on the original image, a workpiece in the new workpiece image has the same shape as the original workpiece; wherein the length of workpiece in the new workpiece image is the same as that of the original workpiece, the width of workpiece in the new workpiece image is different from that of the original workpiece; or wherein the width of workpiece in the new workpiece image is the same as that of the original workpiece, the length of workpiece in the new workpiece image is different from that of the original workpiece. Therefore, the method can identify new workpieces with the same shape but different lengths or widths, especially suitable for mixed sorting scenarios of workpieces.

In some embodiments, generating a new workpiece image in the workpiece image group based on the original image comprises: dividing the original workpiece in the original image into a first region with invariant features and a second region with variable features; changing the length of the second region to generate a second region with changed length; changing the width of the second region to generate a second region with changed width; and combining the first region and the second region with changed length to form the new workpiece image; or combining the first region and the second region with changed width to form the new workpiece image. Therefore, by changing the length or width of the second region with variable features, many types of new workpiece images can be easily generated.

In some embodiments, the method further comprises: obtaining a meta transformer; replacing a feature extraction layer of the meta transformer with multiple feature extraction branches, wherein the multiple feature extraction branches comprise at least one of the following: shortcut to adder; 1×1 convolutional kernel in parallel with pooling unit; 1×1 convolutional kernel in parallel with convolutional unit; and determining the replaced meta transformer as the neural network model. Therefore, replacing the feature extraction layer with multiple feature extraction branches can improve detection performance.

In some embodiments, converting the workpiece detection model into a lightweight workpiece detection model comprises: converting a first batch normalization unit, a first adder connected to the first batch normalization unit, and a shortcut from model input to the first adder in the workpiece detection model into a new first batch normalization unit, based on an identical transformation method; converting a pooling unit, a second adder connected to the pooling unit, a 1×1 convolutional kernel in parallel with the pooling unit, and a shortcut from the first adder to the second adder in the workpiece detection model into a new pooling unit, based on an identical transformation method; converting a dropout unit, a third adder connected to the dropout unit, and a shortcut from the input of the dropout unit to the third adder in the workpiece detection model into a new dropout unit, based on an identical transformation method; converting a second batch normalization unit, a fourth adder connected to the second batch normalization unit, and a shortcut from the input of the second batch normalization unit to the fourth adder in the workpiece detection model into a new second batch normalization unit, based on an identical transformation method; converting a convolutional unit, a fifth adder, a 1×1 convolutional kernel in parallel with the convolutional unit, and a shortcut from the input of the convolutional unit to the fifth adder in the workpiece detection model into a new convolutional unit, based on an identical transformation method; and connecting the new first batch normalization unit, the new pooling unit, the new dropout unit, the new second batch normalization unit, and the new convolution unit in sequence to form a feature detection layer in the lightweight workpiece detection model. Therefore, replacing the components in the feature extraction layer with lightweight components through identity transformation can improve detection speed and reduce storage requirements, especially suitable for edge devices.

In some embodiments, performing training on a neural network model comprising: training the neural network model based on a workpiece image in the workpiece image group comprising a local label of the first region and a local label of the second region, wherein the method comprises: deploying the lightweight workpiece detection model in an edge device; inputting a reference workpiece image comprising preset grasping point coordinates into the lightweight workpiece detection model to output center coordinates of the first region and center coordinates of the second region in the reference workpiece image; storing associatively the center coordinates of the first region in the reference workpiece image, the center coordinates of the second region in the reference workpiece image, and the preset gripping point coordinates; inputting an image of workpiece to be detected into the lightweight workpiece detection model to output center coordinates of the first region in the image of workpiece to be detected and center coordinates of the second region in the image of workpiece to be detected; and determining gripping point coordinates in the image of workpiece to be detected based on the center coordinates of the first region in the reference workpiece image, the center coordinates of the second region in the reference workpiece image, the preset gripping point coordinates, the center coordinates of the first region in the image of workpiece to be detected, and the center coordinates of the second region in the image of workpiece to be detected. Therefore, it may be convenient and flexible to quickly obtain gripping point coordinates of new workpieces, especially suitable for sorting scenarios of mixed workpieces with the same shape but different lengths or widths.

In some embodiments, performing training on a neural network model comprises: training the neural network model based on a workpiece image in the workpiece image group comprising a local label of the first region, a local label of the second region and a global label of the workpiece image, wherein the method comprises: inputting an image comprising multiple workpieces with overlapping relationships into the lightweight workpiece detection model; and obtaining detection results for each of the multiple workpieces from the lightweight workpiece detection model, wherein each detection result for each workpiece comprises first region and second region of corresponding workpiece. The workpiece detection model trained on global and local labels can accurately perform detection for multiple workpieces with overlapping relationships.

Some embodiments include an apparatus for detecting workpiece comprising: a data augmentation module, configured to perform data augmentation on an original image of an original workpiece; a training module, configured to perform training on a neural network model comprising multiple feature extraction branches to obtain a workpiece detection model based on a workpiece image group obtained through the data augmentation; a converting module, configured to convert the workpiece detection model into a lightweight workpiece detection model; and a detecting module, configured to perform detection on workpieces with the same shape and at least one different dimension as the original workpiece based on the lightweight workpiece detection model.

As another example, some embodiments include an electronic device comprising a processor and a memory, wherein an application program executable by the processor is stored in the memory for causing the processor to execute one or more methods as described herein for detecting a workpiece as described in any of the above.

As another example, some embodiments include a computer-readable medium comprising computer-readable instructions stored thereon is provided, wherein the computer-readable instructions, when executed by a processor, implement one or more of the methods for detecting workpiece as described herein.

As another example, some embodiments include a computer program product comprising a computer program, when the computer program is executed by a processor for executing one or more of the methods for detecting a workpiece as described herein.

### BRIEF DESCRIPTION OF THE DRAWINGS

In order to make technical solutions of examples of the present disclosure clearer, accompanying drawings to be used in description of the examples will be simply introduced hereinafter. Obviously, the accompanying drawings to be described hereinafter are only some examples of the present disclosure. Those skilled in the art may obtain other drawings according to these accompanying drawings without creative labor.

FIG. 1 is a flowchart of an example workpiece detection method incorporating teachings of the present disclosure;

FIG. 2A is a first schematic diagram of exemplary workpieces with the same shape and different lengths;

FIG. 2B is a second schematic diagram of exemplary workpieces with the same shape and different lengths;

FIG. 3 is a schematic diagram of an example performing data augmentation processing on a workpiece image incorporating teachings of the present disclosure;

FIG. 4A is a schematic diagram of an example feature extraction layer in a meta transformer;

FIG. 4B is a schematic diagram of an example feature extraction layer participating in training according to an embodiment of the present invention;

FIG. 4C is a schematic diagram of an example feature extraction layer after lightweight incorporating teachings of the present disclosure;

FIG. 5 is a schematic diagram of an example lightweight workpiece detection model obtained through training incorporating teachings of the present disclosure;

FIG. 6 is a schematic diagram of an example identical transformation incorporating teachings of the present disclosure;

FIG. 7 is a comparison of the effect between embodiments of the teachings of the present disclosure and the prior art;

FIG. 8 is a schematic diagram of an example apparatus for detecting a workpiece incorporating teachings of the present disclosure; and

FIG. 9 is a structural diagram of an example electronic device incorporating teachings of the present disclosure.

### LIST OF REFERENCE NUMBERS

| reference numbers | meanings |
|---|---|
| 101~104 | steps |
| 10, 11, 12, 13 | workpieces of the same shape with different lengths |
| 14, 15 | workpieces of the same shape |
| | with different lengths |
| 20 | original workpiece |
| 21, 23 | first region |
| 24 | second region |
| 22 | symbol |
| 241 | subblock |
| 25 | new workpiece image |
| 31 | first batch normalization unit |
| 32 | pooling unit |
| 33 | dropout unit |
| 34, 37 | adder |
| 35 | second batch normalization unit |
| 36 | convolutional unit |
| 80 | feature extraction layer during |
| | training process |
| 41 | first batch normalization unit |
| 42 | first adder |
| 43 | pooling unit |
| 44 | first 1 × 1 convolutional kernel |
| 45 | second adder |
| 46 | dropout unit |
| 47 | third adder |
| 48 | second batch normalization unit |
| 49 | fourth adder |
| 50 | convolutional unit |
| 51 | second 1 × 1 convolutional kernel |
| 52 | fifth adder |
| 90 | lightweight feature extraction |
| | layer |
| 61 | new first batch normalization |
| | unit |
| 62 | new dropout unit |
| 63 | new second batch normalization |
| | unit |
| 64 | new convolutional unit |
| 70 | meta converter architecture |
| 71 | model input |
| 72 | feature extraction layer |
| 73 | classification layer |
| 74 | workpiece detection model |
| 75 | feature extraction layer |
| 84, 86 | original image of original workpiece |
| 83, 85 | images of workpieces with the same shape |
| | and different lengths as the original workpiece |
| 92 | detection results of prior art |
| 93 | detection results of embodiments |
| | of present invention |
| 800 | apparatus for detecting |
| | workpiece |
| 801 | data augmentation module |
| 802 | training module |
| 803 | converting module |
| 804 | detecting module |
| 900 | electronic device |
| 901 | processor |
| 902 | memory |

### DETAILED DESCRIPTION

In order to make the purpose, technical scheme, and advantages of the teachings herein clearer, the following examples are given to further explain the disclosure in detail. In order to be concise and intuitive in description, the teachings are described below by describing several representative embodiments. Many details in the embodiments are only used to help understand. However, teachings can be realized without being limited to these details. In order to avoid unnecessary blurring, some embodiments are not described in detail, but only the framework is given. Hereinafter, “including” refers to “including but not limited to”, “according to . . . ” refers to “at least according to . . . , but not limited to . . . ”. Due to the language habits of Chinese, when the number of an element is not specifically indicated below, it means that the element can be one or more, or can be understood as at least one.

In the industrial field, picking and placing workpieces for self-assembly, printed circuit boards (PCBs) for automatic testing, and electronic waste classification often rely on AI based workpiece detection. AI based workpiece detection requires a long execution time on the GPU and affects the speed of entire process, making it difficult to perform workpiece detection work on industrial edge devices such as SIMATIC 227E, SIMATIC 427E, or SIMATIC S7-1500™ NPU. In addition, in the scenario of mixed sorting of workpieces, it is common to encounter new workpieces that have the same shape as the old one but have a different length or width and another that is the same. Existing technologies often require the use of real workpiece images, including real new workpieces and real old workpieces, to frequently retrain AI models. However, frequent retraining of AI modules means more cost and time.

Some embodiments include a lightweight workpiece detection scheme, which is convenient for implementation at edge devices. Moreover, for new workpieces with the same shape as the old one, but with one different length or width and another identical, there is no need to frequently retrain the model, which can detect new workpieces faster.

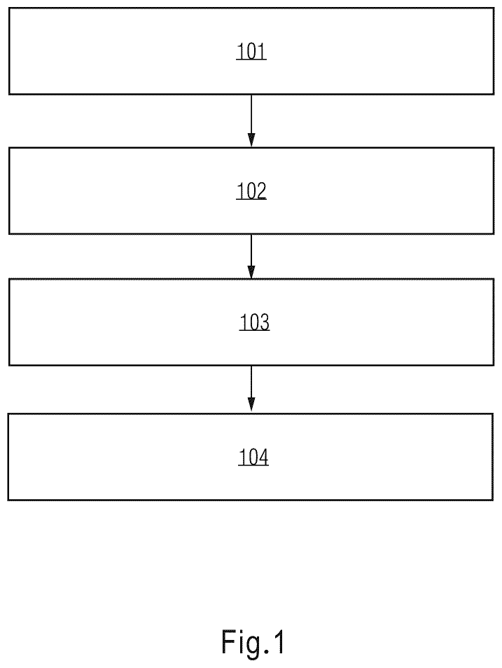

FIG. 1 is a flowchart of an example workpiece detection method incorporating teachings of the present disclosure. As shown in FIG. 1, the method comprises:

Step 101: performing data augmentation on an original image of an original workpiece. A workpiece refers to the processing object in a mechanical processing process, which can be a single part or a combination of several parts fixed together. The meaning of the original image is compared to the new workpiece image obtained by changing size of workpiece, the size of original workpiece containing in the original image has not been changed. The original workpiece is the workpiece contained in the original image. In some embodiments, the original image is a real captured image of the original workpiece.

Here, performing data augmentation on the original image can include:
(1) Based on the original image, generate a new workpiece image comprised in the workpiece image group, where the workpiece in the new workpiece image has the same shape as the original workpiece. Moreover, the workpiece in the new workpiece image has the same length as the original workpiece, while the workpiece in the new workpiece image has a different width from the original workpiece.
(2) Based on the original image, generate a new workpiece image comprised in the workpiece image group, where the workpiece in the new workpiece image has the same shape as the original workpiece. Moreover, the workpiece in the new workpiece image has the same width as the original workpiece, while the workpiece in the new workpiece image has a different length from the original workpiece.

In some embodiments, the workpiece image group may also comprise the original image.

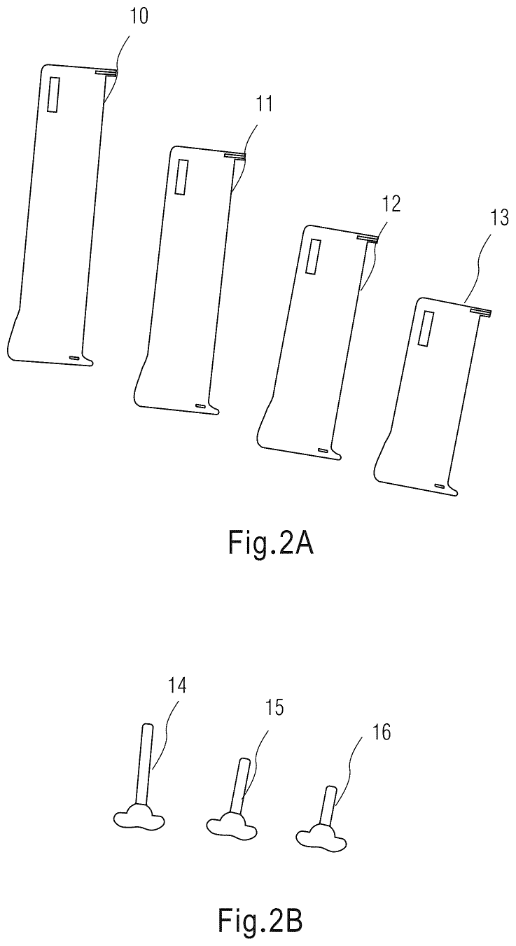

FIG. 2A is a first schematic diagram of exemplary workpieces with the same shape and different lengths. In FIG. 2A, workpiece 10, workpiece 11, workpiece 12, and workpiece 13 all have the same shape and width, and workpiece 10, workpiece 11, workpiece 12, and workpiece 13 each have different lengths. FIG. 2B is a second schematic diagram of exemplary workpieces with the same shape and different lengths according to the embodiment of the present invention. In FIG. 2B, workpiece 14, workpiece 15, and workpiece 16 all have the same shape and width, and workpiece 14, workpiece 15, and workpiece 16 each have different lengths.

In some embodiments, step 101 includes:
Sub step (1): Divide the original workpiece into a first region with invariant features and a second region with variable features;
Sub step (2): Change the length of the second region to generate a second region with changed length; Alternatively, change the width of the second region to generate a second region with changed width.
Sub step (3): Combine the first region and the second region with changed length into a new workpiece image. Alternatively, combine the first region and the second region with changed width to create a new workpiece image.

For example, the first region can be implemented as a textured region, while the second region can be implemented as a texture less region.

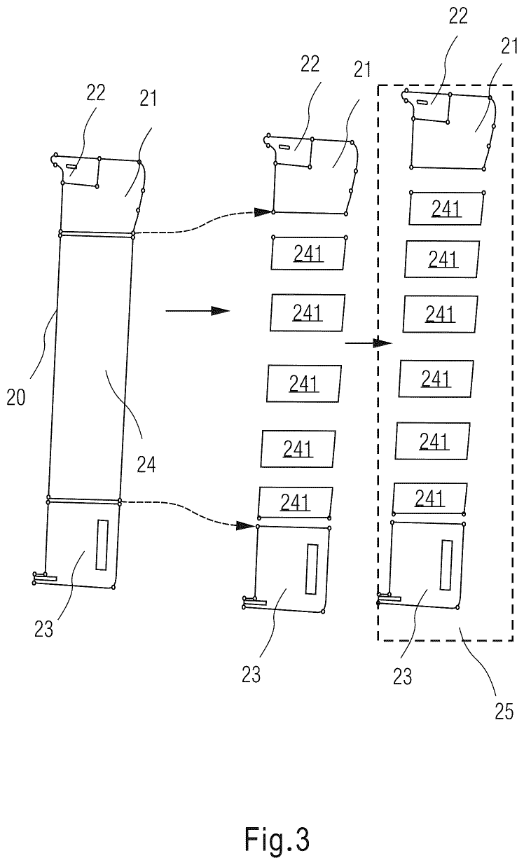

FIG. 3 is a schematic diagram of performing data enhancement processing on a workpiece image incorporating teachings of the present disclosure. The workpiece image 20 includes first regions 21, 23, and second region 24. In the first region 21, there is also a symbol 22 (for example, implemented as a workpiece Logo). The first regions 21 and 23 have a specific shape and are not altered in length. The second region 24 is a texture less region that can be changed in length. Firstly, divide the workpiece image 20 into first regions 21, 23, and second region 24. Next, divide the second region 24 evenly into several sub blocks 241, such as 5 sub blocks. Next, sub block 241 can be copied to increase the length of the second region 24, or sub block 241 can be deleted to reduce the length of the second region 24. Finally, recombine the second region 24 with the first regions 21 and 23 after the length change to obtain a new workpiece image. For example, adding a sub block 241 in the second region 24 (totaling 6 sub blocks 241), and then recombining the second region 24 containing 6 sub blocks 241 with the first regions 21 and 23 to obtain a new workpiece image 25.

In FIG. 3, an example of increasing the length of the workpiece to achieve data augmentation is illustrated, and in fact, the length of the workpiece can also be reduced to achieve data augmentation. In some embodiments, the length of the workpiece can be kept constant and the width of the workpiece can be changed to achieve data augmentation.

Step 102: performing training on a neural network model comprising multiple feature extraction branches to obtain a workpiece detection model based on a workpiece image group obtained through the data augmentation. Here, the workpiece image group may include: the workpiece image (original image) before data enhancement in step 101 and the new workpiece image generated based on data enhancement in step 101.

In some embodiments, the process of obtaining a neural network model comprising multiple feature extraction branches specifically includes: obtaining a meta transformer; replace the feature extraction layer of the meta transformer with multiple feature extraction branches, including at least one of the following: short cut to adder; 1×1 convolutional kernel in parallel with pooling units; 1×1 convolutional kernel in parallel with convolutional units; determining the replaced meta transformer as a neural network model.

Meta transformer is a new framework for multimodal learning, which is used to process and associate information from multiple modalities. Although there are inherent gaps between various data, the meta transformer utilizes a frozen encoder to extract advanced semantic features from input data in a shared tag space, without the need for paired multimodal training data. This framework consists of a unified data marker, a pattern sharing encoder, and task headers for various downstream tasks.

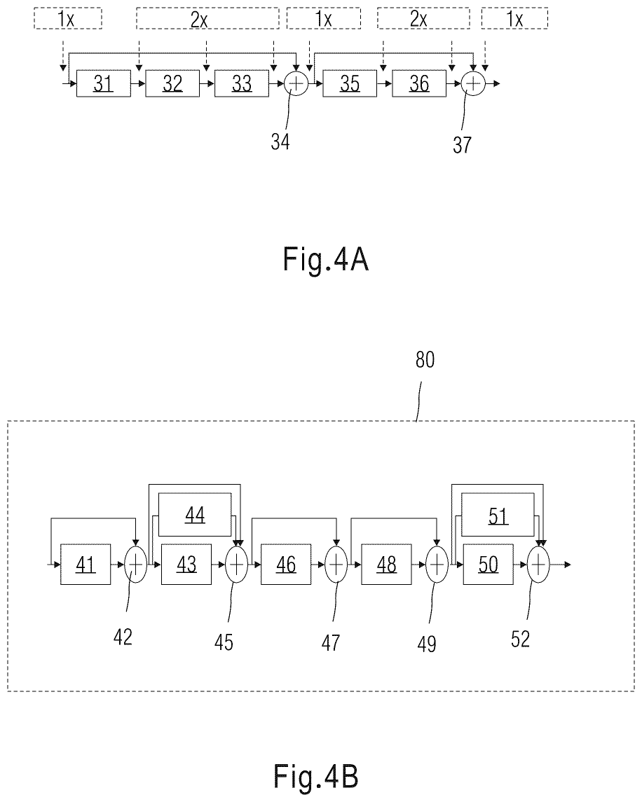

FIG. 4A is a schematic diagram of the feature extraction layer in a meta converter. The feature extraction layer in the meta transformer includes: first batch normalization (BN) unit 31, pooling unit 32, drop out unit 33, second BN unit 35, convolution unit 36, adder 33 connected between drop out unit 33 and second BN unit 35, and adder 37 after convolution unit 36. Among them, the data input of pooling unit 32, data input of drop out unit 33, and data input of convolution unit 36 all require 2 storage spaces (2×memory).

At present, there are few feature extraction branches in the feature extraction layer of the meta transformer, which makes it difficult to ensure detection effect. By replacing the feature extraction layer of the meta transformer with multiple feature extraction branches, the detection effect can be improved. Multiple feature extraction branches can be achieved through various methods, such as adding at least one of the following: short cut to adder; 1×1 convolutional kernel in parallel with pooling unit; 1×1 convolutional kernel in parallel with convolutional unit, and so on.

FIG. 4B is a schematic diagram of the feature extraction layer participating in training incorporating teachings of the present disclosure. In FIG. 4B, the feature extraction layer 80 includes: first BN unit 41, first adder 42, pooling unit 43, first 1×1 convolution core 44, second adder 45, drop out unit 46, third adder 47, second BN unit 48, fourth adder 49, convolution unit 50 (such as 3×3 convolution core), second 1×1 convolution core 51, and fifth adder 52. Moreover, the output of the first adder 42 has a short cut to the input of the second adder 45. The output of the second adder 45 has a short cut to the input of the third adder 47. The output of the third adder 47 has a short cut to the input of the fourth adder 49. The output of the fourth adder 49 has a short cut to the input of the fifth adder 52. The first 1×1 convolution kernel 44 is parallel to pooling unit 43, and the second 1×1 convolution kernel 51 is parallel to the convolution unit 50.

Compared to the feature extraction layer in the meta converter, the feature extraction layer 80 participating in the training has more feature extraction branches, thus having better feature extraction performance. Based on the workpiece image group obtained after data augmentation (including the original workpiece image before data augmentation and the new workpiece images generated based on data augmentation), a meta transformer with a replaced feature extraction layer is trained to obtain a workpiece detection model suitable for detecting workpieces with the same shape and at least one different dimension as the original workpiece.

Step 103: converting the workpiece detection model into a lightweight workpiece detection model. Here, based on identity transformation method, the workpiece detection model in step 102 is transformed into a lightweight workpiece detection model, which facilitates the deployment of workpiece detection model at edge devices.

FIG. 4C is a schematic diagram of feature extraction layer after lightweight incorporating teachings of the present disclosure. As shown in FIG. 4C, lightweight conversion can include:
(1) Based on identical transformation method, the first BN unit 41, the first adder 42 connected to the first BN unit 41, and a short cut from the model input to the first adder 42 are converted into a new first BN unit 60.
(2) Based on identical transformation method, pooling unit 43, the second adder 45 connected to pooling unit 43, 1×1 convolutional kernel 44 in parallel with pooling unit 43, and a short cut from the first adder 43 to the second adder 43 are converted into a new pooling unit 61.
(3) Based on identical transformation method, drop out unit 46, third adder 47 connected to the drop out unit 46, and a short cut from the input of the drop out unit 46 to third adder 47 are converted into a new drop out unit 62.
(4) Based on identical transformation method, second BN unit 48, fourth adder 49 connected to the second BN unit 48, and short cut from the input of the second BN unit 48 to fourth adder 49 are converted into a new second BN unit 63.
(5) Based on identical transformation method, convolutional unit 50, fifth adder 52, 1×1 convolutional kernel 51 in parallel with convolutional unit 50, and short cut from the input of convolutional unit 50 to the fifth adder 52 are converted into a new convolutional unit 64.

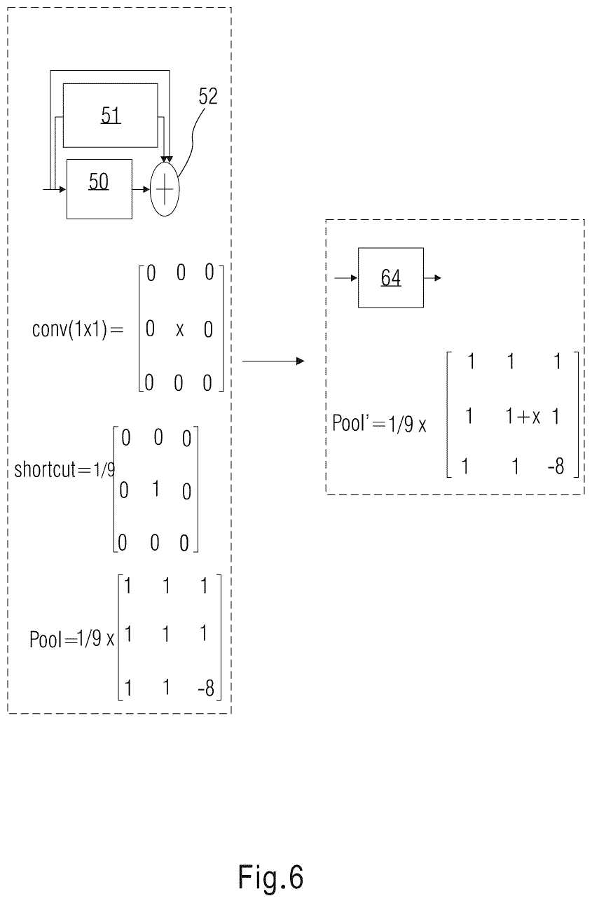

FIG. 6 is a schematic diagram of an example identical transformation incorporating teachings of the present disclosure. In FIG. 6, pooling unit 43, second adder 45 connected to pooling unit 43, 1×1 convolutional kernel 44 in parallel with pooling unit 43, and short cut from the first adder 43 to the second adder 43 l are converted into a new pooling unit 61.

Connect the new first BN unit 60, the new pooling unit 61, the new drop out unit 62, the new second BN unit 63, and the new convolution unit 64 in sequence to form a feature detection layer 90 in the lightweight workpiece detection model. In the feature detection layer 90 of the lightweight workpiece detection model, one storage space (1×memory) is required for data storage, thus reducing storage pressure.

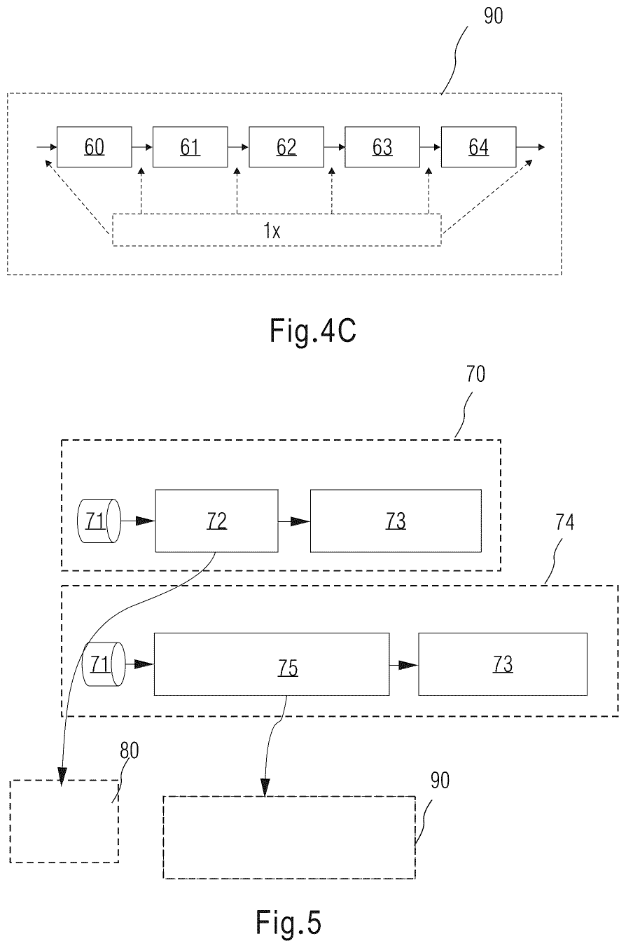

FIG. 5 is a schematic diagram of lightweight workpiece detection model obtained through training incorporating teachings of the present disclosure. The meta transformer architecture 70 includes model input 71, feature extraction layer 72, and classification layer 73. For example, the feature extraction layer 72 has a structure shown in FIG. 4A.

Firstly, replace the feature extraction layer 72 in the meta transformer architecture 70 with the feature extraction layer 80 in FIG. 4B. Then, using workpiece images in the workpiece image group, to train the meta transformer architecture 70 (where the feature extraction layer 72 is replaced by the feature extraction layer 80). The workpiece image group includes original workpiece image and new workpiece images, where new workpiece images have the same shape and different widths or lengths as the original workpiece. The feature extraction layer 75 in the trained meta converter architecture 74 is transformed into lightweight feature extraction layer 90 in FIG. 4C through identity transformation, thereby obtaining a lightweight workpiece detection model. Then, the lightweight workpiece detection model can be deployed to industrial edge devices to detect mixed workpieces with the same shape and different lengths or widths.

Step 104: performing detection on workpieces with the same shape and at least one different dimension as the original workpiece based on the lightweight workpiece detection model. Here, detecting workpieces can include identifying workpieces, classifying workpieces, and locating workpieces, among others.

In some embodiments, step 102 includes: training a neural network model based on a workpiece image group containing images with local labels of the first region and the second region therein, to obtain a workpiece detection model with the ability to detect the first and second regions. This method includes: deploying the lightweight workpiece detection model in an edge device; inputting a reference workpiece image comprising preset grasping point coordinates into the lightweight workpiece detection model to output center coordinates of the first region center coordinates of the second region in the reference workpiece image; storing associatively the center coordinates of the first region in the reference workpiece image, the center coordinates of the second region in the reference workpiece image, and the preset gripping point coordinates; inputting an image of workpiece to be detected into the lightweight workpiece detection model to output center coordinates of the first region in the image of workpiece to be detected and center coordinates of the second region in the image of workpiece to be detected; determining gripping point coordinates in the image of workpiece to be detected based on the center coordinates of the first region in the reference workpiece image, the center coordinates of the second region in the reference workpiece image, the preset gripping point coordinates, the center coordinates of the first region in the image of workpiece to be detected, and the center coordinates of the second region in the image of workpiece to be detected.

For example, user calibrates gripping point in the reference workpiece image, assuming that the gripping point coordinates are (x_{b}, y_{b}). Input the reference workpiece image into the lightweight workpiece detection model in edge device to detect center coordinates (xₐ, yₐ) of the first region in the reference workpiece image and center coordinates (x_{c}, y_{c}) of the second region in the reference workpiece image. Then, associatively store center coordinates of the first region (xₐ, yₐ), center coordinates of the second region (x_{c}, y_{c}), and coordinates of the grasping point (x_{b}, y_{b}). Next, input an image of workpiece to be detected (such as the workpiece in the image of the workpiece to be detected having the same shape and different length as the reference workpiece in the reference workpiece image) into the lightweight workpiece detection model. The lightweight workpiece detection model outputs center coordinates (x_{newa}, y_{newa}) of the first region in the workpiece image to be detected and center coordinates (x_{newc}, y_{newc}) of the second region in the workpiece image to be detected by the lightweight workpiece detection model.

Then, the coordinates (x_{newb}, y_{newb}) of the gripping point in the image of the workpiece to be detected can be calculated as:

$${x}_{newb} = \frac{{x}_{newa + \frac{{x}_{b} - {x}_{a}}{{x}_{c} - {x}_{b}} * {x}_{newc}}}{1 + \frac{{x}_{b} - {x}_{a}}{{x}_{c} - {x}_{b}}} ; {y}_{newb} = \frac{{y}_{newa + \frac{{y}_{b} - {y}_{a}}{{y}_{c} - {y}_{b}} * {y}_{newc}}}{1 + \frac{{y}_{b} - {y}_{a}}{{y}_{c} - {y}_{b}}}$$

Therefore, it is convenient and flexible to quickly obtain the gripping point coordinates of new workpieces, especially suitable for sorting scenarios of mixed workpieces with the same shape but different lengths or widths.

In some embodiments, step 102 includes: training the neural network model based on global label of workpiece image, local label of the first region, and local label of the second region to obtain the workpiece detection model. The workpiece detection model can detect the overall contour of the workpiece image, as well as the respective contours of the first and second regions in the workpiece image. Step 104 includes: inputting the tested image containing multiple workpieces with overlapping relationships into a lightweight workpiece detection model; Obtain the detection results of each workpiece from a lightweight workpiece detection model, where the detection results of each workpiece include their respective first region and second region. The overall contour to which the component belongs can be determined based on the overall contour with the maximum overlap among multiple overall contours determined by the component (including the first and second regions) and the global label.

For example, if three workpieces in the image have overlapping relationships, the workpiece detection model recognizes: overall contour 1 of the first workpiece, overall contour 2 of the second workpiece, and overall contour 3 of the third workpiece. The workpiece detection model also recognizes: first region 1, first region 2, and first region 3 in the three workpieces; second region 1, second region 2, and second region 3 in the three workpieces. If the overall contour that most overlaps with the first region 1 is overall contour 1, and the overall contour that most overlaps with the second region 2 is overall contour 1. Then determine that the first region 1 and the second region 2 are components of the overall contour 1. Similarly, determine the respective components of overall contour 2 and overall contour 3.

The workpiece detection model based on global and local label training can accurately detect multiple workpieces with overlapping relationships separately.

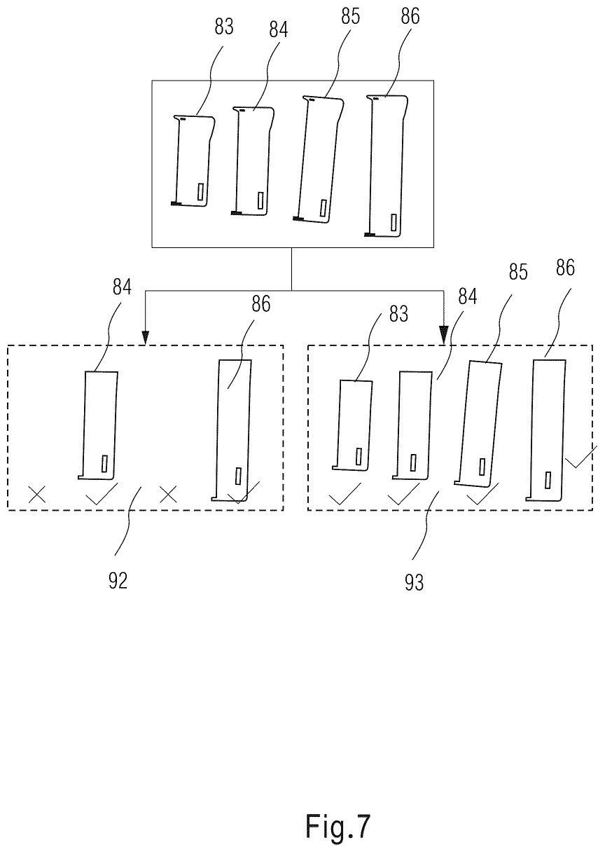

FIG. 7 is a comparison of the effect between embodiments of the present disclosure and the prior art. A workpiece detection model in prior art is trained through original workpiece image 84 and original workpiece 86 image. Input original workpiece image 84, original workpiece image 86, and workpiece images 83 and 85 with the same shape and different lengths as original workpiece image into workpiece detection model in prior art and obtain detection results 92. According to detection results 92, only original workpiece image 84 and the original workpiece image 86 can be recognized, but the workpiece images 83 and 85 cannot be recognized.

In some embodiments, data augmentation processing is performed on the original workpiece image 84 (or original workpiece image 86) to generate workpiece images 83, 85 with the same shape and different lengths as the original workpiece image. A workpiece detection model is trained through original workpiece image 84, original workpiece 86 image, and workpiece images 83, 85. Input original workpiece image 84, original workpiece image 86, and workpiece images 83 and 85 with the same shape and different lengths as the original workpiece image into the workpiece detection model to obtain detection results. In the detection results, both original workpiece images 84, 86 and workpiece images 83 and 85 can be recognized.

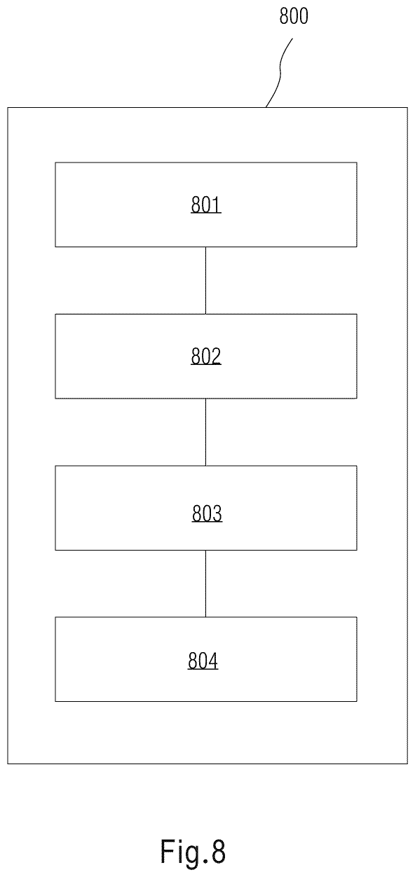

FIG. 8 is a schematic diagram of an example apparatus for detecting workpiece incorporating teachings of the present disclosure. As shown in FIG. 8, apparatus 800 for detecting workpiece includes: a data augmentation module 801, configured to perform data augmentation on an original image of an original workpiece; a training module 802, configured to perform training on a neural network model comprising multiple feature extraction branches to obtain a workpiece detection model based on a workpiece image group obtained through the data augmentation; a converting module 803, configured to convert the workpiece detection model into a lightweight workpiece detection model; and a detecting module 804, configured to perform detection on workpieces with the same shape and at least one different dimension as the original workpiece based on the lightweight workpiece detection model.

In some embodiments, data augmentation module 801, configured to generate a new workpiece image in the workpiece image group based on the original image, a workpiece in the new workpiece image has the same shape as the original workpiece; wherein the length of workpiece in the new workpiece image is the same as that of the original workpiece, the width of workpiece in the new workpiece image is different from that of the original workpiece; or wherein the width of workpiece in the new workpiece image is the same as that of the original workpiece, the length of workpiece in the new workpiece image is different from that of the original workpiece.

In some embodiments, data augmentation module 801, configured to divide the original workpiece in the original image into a first region with invariant features and a second region with variable features; change the length of the second region to generate a second region with changed length; change the width of the second region to generate a second region with changed width; combine the first region and the second region with changed length to form the new workpiece image; or combining the first region and the second region with changed width to form the new workpiece image.

In some embodiments, training module 802, configured to obtain a meta transformer; replace a feature extraction layer of the meta transformer with multiple feature extraction branches, wherein the multiple feature extraction branches comprise at least one of the following: shortcut to adder; 1×1 convolutional kernel in parallel with pooling unit; 1×1 convolutional kernel in parallel with convolutional unit; determine the replaced meta transformer as the neural network model.

In some embodiments, converting module 803, configured to convert a first batch normalization unit, a first adder connected to the first batch normalization unit, and a shortcut from model input to the first adder in the workpiece detection model into a new first batch normalization unit, based on an identical transformation method; convert a pooling unit, a second adder connected to the pooling unit, a 1×1 convolutional kernel in parallel with the pooling unit, and a shortcut from the first adder to the second adder in the workpiece detection model into a new pooling unit, based on an identical transformation method; convert a dropout unit, a third adder connected to the dropout unit, and a shortcut from the input of the dropout unit to the third adder in the workpiece detection model into a new dropout unit, based on an identical transformation method; convert a second batch normalization unit, a fourth adder connected to the second batch normalization unit, and a shortcut from the input of the second batch normalization unit to the fourth adder in the workpiece detection model into a new second batch normalization unit, based on an identical transformation method; convert a convolutional unit, a fifth adder, a 1×1 convolutional kernel in parallel with the convolutional unit, and a shortcut from the input of the convolutional unit to the fifth adder in the workpiece detection model into a new convolutional unit, based on an identical transformation method; connect the new first batch normalization unit, the new pooling unit, the new dropout unit, the new second batch normalization unit, and the new convolution unit in sequence to form a feature detection layer in the lightweight workpiece detection model.

In some embodiments, training module 802, configured to train the neural network model based on a workpiece image in the workpiece image group comprising a local label of the first region and a local label of the second region; detecting module 804, configured to deploy the lightweight workpiece detection model in an edge device; input a reference workpiece image comprising preset grasping point coordinates into the lightweight workpiece detection model to output center coordinates of the first region and center coordinates of the second region in the reference workpiece image; store associatively the center coordinates of the first region in the reference workpiece image, the center coordinates of the second region in the reference workpiece image, and the preset gripping point coordinates; input an image of workpiece to be detected into the lightweight workpiece detection model to output center coordinates of the first region in the image of workpiece to be detected and center coordinates of the second region in the image of workpiece to be detected; determine gripping point coordinates in the image of workpiece to be detected based on the center coordinates of the first region in the reference workpiece image, the center coordinates of the second region in the reference workpiece image, the preset gripping point coordinates, the center coordinates of the first region in the image of workpiece to be detected, and the center coordinates of the second region in the image of workpiece to be detected.

In some embodiments, training module 802, configured to train the neural network model based on a workpiece image in the workpiece image group comprising a local label of the first region, a local label of the second region and a global label of the workpiece image; detecting module 804, configured to input an image comprising multiple workpieces with overlapping relationships into the lightweight workpiece detection model; obtain detection results for each of the multiple workpieces from the lightweight workpiece detection model, wherein each detection result for each workpiece comprises first region and second region of corresponding workpiece.

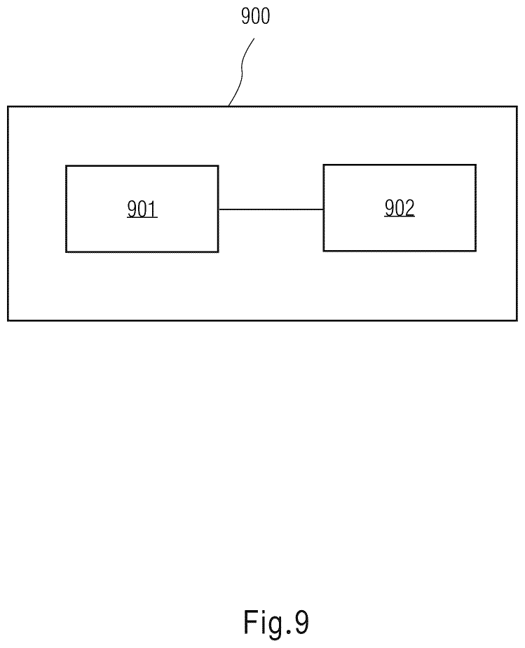

In some embodiments, there is an electronic device with a processor memory architecture. FIG. 9 is a structural diagram of an example electronic device with a processor memory architecture incorporating teachings of the present disclosure. As shown in FIG. 9, electronic device 900 includes a processor 901, a memory 902, and a computer program stored on memory 902 that can run on processor 901. When the computer program is executed by processor 901, the workpiece detection method as described in either of the above methods is implemented. Among them, memory 902 can be implemented as various storage media such as electrically erasable programmable read-only memory (EEPROM), flash memory, programmable program read-only memory (PROM), etc. Processor 901 can be implemented to include one or more central processors or one or more field programmable gate arrays, wherein the field programmable gate array integrates one or more central processor cores. Specifically, the central processing unit or core can be implemented as a CPU, MCU, DSP, and so on.

It should be noted that not all steps and modules in the above processes and structural diagrams are necessary, and some steps or modules can be ignored according to actual needs. The execution sequence of each step is not fixed and can be adjusted as needed. The division of each module is only for the convenience of describing the functional division used. In actual implementation, a module can be divided into multiple modules, and the functions of multiple modules can also be implemented by the same module. These modules can be in the same device or different devices.

The hardware modules in each implementation can be implemented mechanically or electronically. For example, a hardware module can include specially designed permanent circuits or logic devices (such as dedicated processors, such as FPGA or ASIC) to complete specific operations. Hardware modules can also include programmable logic devices or circuits temporarily configured by software (such as general-purpose processors or other programmable processors) for performing specific operations. As for the specific use of mechanical methods, either dedicated permanent circuits or temporarily configured circuits (such as software configuration) to implement hardware modules, it can be determined based on cost and time considerations.

The above is only an example embodiment of the present disclosure and is not intended to limit the scope of protection thereof. Any modifications, equivalent substitutions, improvements, etc. made within the spirit and principles of this disclosure shall be included within the scope of protection thereof.

What is claimed is:

1. A method for detecting a workpiece, the method comprising:
performing data augmentation on an original image of an original workpiece;
performing training on a neural network model comprising multiple feature extraction branches to obtain a workpiece detection model based on a workpiece image group obtained through the data augmentation;
converting the workpiece detection model into a lightweight workpiece detection model; and
performing detection on workpieces with the same shape and at least one different dimension as the original workpiece based on the lightweight workpiece detection model.

2. The method of claim 1, wherein performing data augmentation on an original image of an original workpiece comprises:
generating a new workpiece image in the workpiece image group based on the original image, a workpiece in the new workpiece image has the same shape as the original workpiece;
wherein the length of workpiece in the new workpiece image is the same as that of the original workpiece and the width of workpiece in the new workpiece image is different from that of the original workpiece; or
wherein the width of workpiece in the new workpiece image is the same as that of the original workpiece and the length of workpiece in the new workpiece image is different from that of the original workpiece.

3. The method of claim 2, wherein generating a new workpiece image in the workpiece image group based on the original image comprises:
dividing the original workpiece in the original image into a first region with invariant features and a second region with variable features;
changing the length of the second region to generate a second region with changed length;
changing the width of the second region to generate a second region with changed width;
combining the first region and the second region with changed length to form the new workpiece image; or combining the first region and the second region with changed width to form the new workpiece image.

4. The method of claim 1, comprising:
obtaining a meta transformer;
replacing a feature extraction layer of the meta transformer with multiple feature extraction branches, wherein the multiple feature extraction branches comprise at least one of the following: shortcut to adder, 1×1 convolutional kernel in parallel with pooling unit, and 1×1 convolutional kernel in parallel with convolutional unit;
determining the replaced meta transformer as the neural network model.

5. The method of claim 4, wherein converting the workpiece detection model into a lightweight workpiece detection model comprises:
converting a first batch normalization unit, a first adder connected to the first batch normalization unit, and a shortcut from model input to the first adder in the workpiece detection model into a new first batch normalization unit, based on an identical transformation method;
converting a pooling unit, a second adder connected to the pooling unit, a 1×1 convolutional kernel in parallel with the pooling unit, and a shortcut from the first adder to the second adder in the workpiece detection model into a new pooling unit, based on an identical transformation method;
converting a dropout unit, a third adder connected to the dropout unit, and a shortcut from the input of the dropout unit to the third adder in the workpiece detection model into a new dropout unit, based on an identical transformation method;
converting a second batch normalization unit, a fourth adder connected to the second batch normalization unit, and a shortcut from the input of the second batch normalization unit to the fourth adder in the workpiece detection model into a new second batch normalization unit, based on an identical transformation method;
converting a convolutional unit, a fifth adder, a 1×1 convolutional kernel in parallel with the convolutional unit, and a shortcut from the input of the convolutional unit to the fifth adder in the workpiece detection model into a new convolutional unit, based on an identical transformation method; and
connecting the new first batch normalization unit, the new pooling unit, the new dropout unit, the new second batch normalization unit, and the new convolution unit in sequence to form a feature detection layer in the lightweight workpiece detection model.

6. The method of claim 3, wherein performing training on a neural network model comprises training the neural network model based on a workpiece image in the workpiece image group comprising a local label of the first region and a local label of the second region; and
the method further comprises:
deploying the lightweight workpiece detection model in an edge device;
inputting a reference workpiece image comprising preset grasping point coordinates into the lightweight workpiece detection model to output center coordinates of the first region and center coordinates of the second region in the reference workpiece image;
storing associatively the center coordinates of the first region in the reference workpiece image, the center coordinates of the second region in the reference workpiece image, and the preset gripping point coordinates;
inputting an image of workpiece to be detected into the lightweight workpiece detection model to output center coordinates of the first region in the image of workpiece to be detected and center coordinates of the second region in the image of workpiece to be detected; and
determining gripping point coordinates in the image of workpiece to be detected based on the center coordinates of the first region in the reference workpiece image, the center coordinates of the second region in the reference workpiece image, the preset gripping point coordinates, the center coordinates of the first region in the image of workpiece to be detected, and the center coordinates of the second region in the image of workpiece to be detected.

7. The method of claim 3, wherein performing training on a neural network model comprises training the neural network model based on a workpiece image in the workpiece image group comprising a local label of the first region, a local label of the second region and a global label of the workpiece image; and
the method further comprises:
inputting an image comprising multiple workpieces with overlapping relationships into the lightweight workpiece detection model; and
obtaining detection results for each of the multiple workpieces from the lightweight workpiece detection model, wherein each detection result for each workpiece comprises first region and second region of corresponding workpiece.

8. An apparatus for detecting workpiece, the apparatus comprising:
a data augmentation module to perform data augmentation on an original image of an original workpiece;
a training module to perform training on a neural network model comprising multiple feature extraction branches to obtain a workpiece detection model based on a workpiece image group obtained through the data augmentation;
a converting module to convert the workpiece detection model into a lightweight workpiece detection model; and
a detecting module to perform detection on workpieces with the same shape and at least one different dimension as the original workpiece based on the lightweight workpiece detection model.

9. An electronic device comprising:
a processor; and
a memory storing an application program executable by the processor;
the program causing the processor to:
perform data augmentation on an original image of an original workpiece;
perform training on a neural network model comprising multiple feature extraction branches to obtain a workpiece detection model based on a workpiece image group obtained through the data augmentation;
convert the workpiece detection model into a lightweight workpiece detection model; and
perform detection on workpieces with the same shape and at least one different dimension as the original workpiece based on the lightweight workpiece detection model.
